(19) United States
(12) Patent Application Publication
(10) Pub. No.: US 2011/0268290 A1
(43) Pub. Date: Nov. 3, 2011

(54) Fan Cooled Headset

(76) Inventor: Steve Bac Lee, Baldwin Park, CA (US)

(21) Appl. No.: 13/033,843

(22) Filed: Feb. 24, 2011

Related U.S. Application Data
(60) Provisional application No. 61/329,708, filed on Apr. 30, 2010.

(51) Int. Cl. H04R 1/10

(52) U.S. Cl. 381/74

(57) ABSTRACT

A fan cooled headset includes at least one fan drawing air into or out of the headset and through ear chambers surrounding the wearer's ears, providing a flow of cool air. A single fan may be located at the top of a head piece, or two fans may be located on sides of the headpiece, or on the ear pieces. Power provided through a USB connection may be used to power the fans to avoid a need for batteries.

The present application claims the priority of U.S. Provisional Patent Application Ser. No. 61/329,708 filed Apr. 30, 2010, which application is incorporated in its entirety herein by reference

### BACKGROUND OF THE INVENTION

The present invention relates to headsets, and in particular to headsets having a fan generated flow of air around a wearer's ears.

Headset users often must deal with different types of discomfort. Such headsets have been used for many years to listen to music, and are more recently used by computer gamers. Computer games continue to grow in popularity and many internet based games allow multiple gamers to participate in very realistic games. The games have grown in realism and gamers often spend many hours at continuous play.

One major discomfort which has risen results from the temperature increase inside the volume around the human ear after a period of use. This discomfort grows as the length of continuous use extends.

### BRIEF SUMMARY OF THE INVENTION

The present invention addresses the above and other needs by providing a fan cooled headset which includes at least one fan drawing air into or out of the headset and through ear chambers surrounding the wearer's ears, providing a flow of cool air. A single fan may be located at the top of a head piece, or two fans may be located on sides of the headpiece, or on the ear pieces. Power provided through a USB connection may be used to power the fans to avoid a need for batteries.

In accordance with one aspect the invention, there is provided a headset with one or more fans providing a flow of air to earpieces.

In accordance with another aspect of the invention, there is provided a headset with air flow channels designed to aid in the transfer of air to the earpieces.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a front view of a fan cooler headset according to the present invention.

FIG. 1B is a top view of the fan cooler headset according to the present invention.

FIG. 1C is a bottom view of the fan cooler headset according to the present invention.

FIG. 2A is a cross-sectional view of a first fan cooler headset, taken along line 2-2 of FIG. 1B, having a single fan centered on a head piece of the headset according to the present invention.

FIG. 2B is a cross-sectional view of a second fan cooler headset, taken along line 2-2 of FIG. 1B, having two fans on opposite sides of the head piece of the headset according to the present invention.

FIG. 2C is a cross-sectional view of a third fan cooler headset taken along line 2-2 of FIG. 1B having two fans on ear pieces of the headset according to the present invention.

FIG. 2D is a cross-sectional view of a fourth fan cooler headset taken along line 2-2 of FIG. 1B having cooling chips residing in passages of the head piece of the headset according to the present invention.

FIG. 3A is a front view of a headset according to the present invention including a microphone.

FIG. 3B is a top view of the headset according to the present invention including the microphone.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

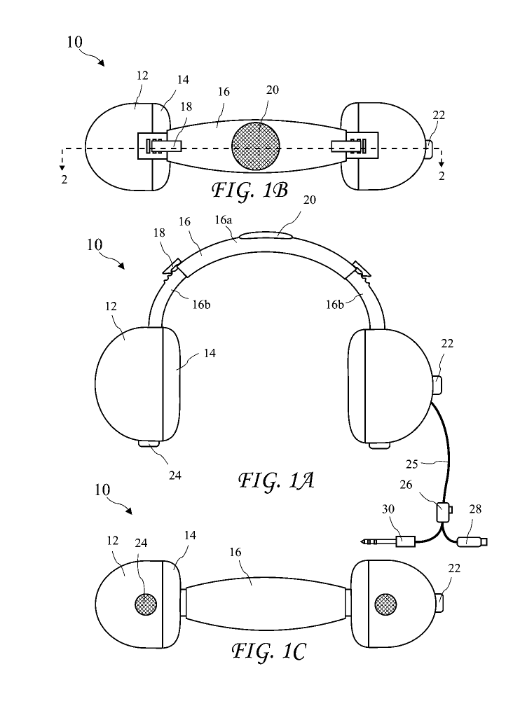

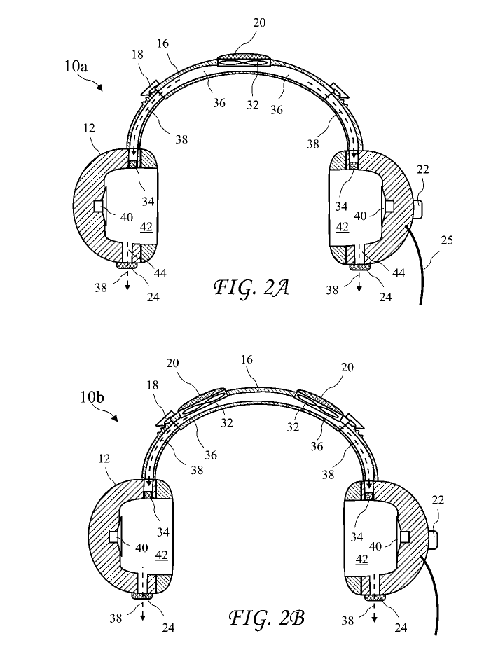

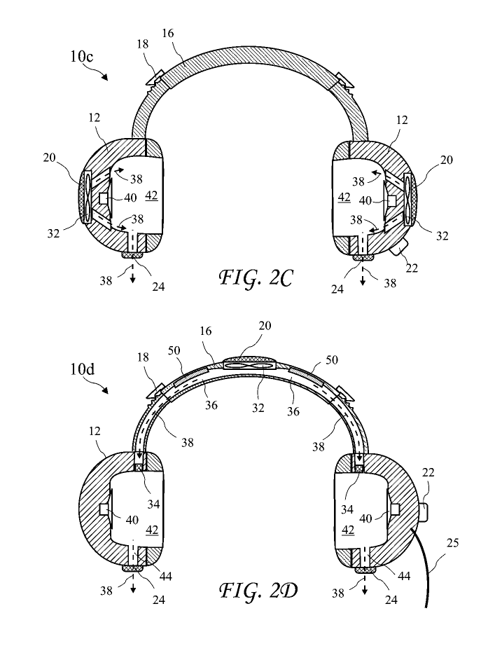

A front view of a fan cooler headset 10 according to the present invention is shown in FIG. 1A, a top view of the fan cooler headset 10 is shown in FIG. 1B, and a bottom view of the fan cooler headset 10 is shown in FIG. 1C. The fan cooler headset 10 includes ear pieces 12 worn over a wearer's ears and a head piece 16 connecting the ear pieces 12 and worn over the wearer's head. Soft cushions 14 are generally attached to the ear pieces 12 to provide comfort to the wearer. The head piece 16 is commonly adjustable having ends 16b telescoping from a center 16a and some form of latch 18 for holding the ends 16b in position after adjusting. The fan cooler headset 10 according to the present invention further includes at least one fan 32 (see FIGS. 2A-2C), filters 20 and 24, and air passages to carry a flow of cooling ambient air to and/or from the wearer's ears. A control 22 may be positioned on the head piece 16 or one of the ear pieces 12, of a second control 26 may be on a cable 25 carrying an audio signal and in some cases, power to the fan. The cable 25 further connects the fan cooler headset 10 to an audio plug 30 and/or to a USB plug 28. Preferably, the fans receive a power signal commonly present in a USB plug 28, and both speaker signals provided to the headset 10, and microphone signals provided from the headset 10, may be carried through the USB plug 28. The control 26 may be used to select between audio signals on the audio plug 30 and the USB plug 28.

A cross-sectional view of a first fan cooler headset 10a, taken along line 2-2 of FIG. 1B, having a single fan (or ducted fan or blower) 32 centered on the head piece 16 of the headset 10a according to the present invention. The headset 10a includes ear volumes 42 in the ear pieces 12, and speakers 40 projecting sound into the ear volumes 42 for hearing by the wearer. The fan 32 resides under a filter 20 for filtering air drawn into the headset 10a. The air flows 38 pass through passages 36 in the head piece 16 and into the ear volumes 42 in the ear pieces 12, and out of the ear volumes 42 through passages 44.

In an alternative embodiment, the fan 32 may draw air from the ear volumes 42 and filters 24 may be placed over the ports 44 to filter air entering the headset 10a.

A cross-sectional view of a second fan cooler headset 10b, taken along line 2-2 of FIG. 1B, having two fans 32 on opposite sides of the head piece 16 of the headset, according to the present invention, is shown in FIG. 2B. The headset 10b is otherwise similar to the headset 10a, and the fans 32 may draw air into the headset 10b, or draw air from the headset 10b.

A cross-sectional view of a third fan cooler headset 10c taken along line 2-2 of FIG. 1B, having two fans on ear pieces of the headset according to the present invention, is shown in FIG. 2C. The headset 10c is otherwise similar to the headset 10a, and the fans 32 may draw air into the ear pieces 12, or draw air from the ear pieces 12.

A cross-sectional view of a fourth fan cooler headset 10D taken along line 2-2 of FIG. 1B having cooling chips 50 residing in passages 36 of the head piece 16. The cooling chips 50 preferably receive power through the USB connection and are also referred to as chip-integrated micro cooling device. The cooling chips preferably have a hot side residing against an outside surface of the head piece 16 to avoid projecting heat towards the wearer's head and a cold side in the passages 36 to cool an air flow to the wearer's ears. The cooling chips 50 may also reside in the ear pieces 12 with cool sides in the ear volumes 42.

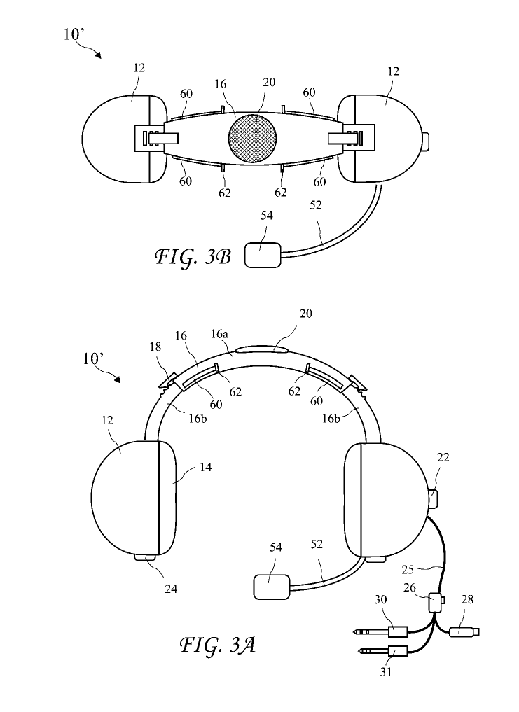

A front view of a headset 10′ according to the present invention including a microphone 54 connected to the ear piece 12 by a stalk 52 is shown in FIG. 3A and a top view of the headset 10 according to the present invention including the microphone 54 connected to the ear piece 12 by a stalk 52 is shown in FIG. 3B. Computer games often include interactions between players requiring such microphone 54. The headset 10′ includes a microphone plug 31 along with the audio plug 30 and the USB plug 28.

The headset 10′ may further include vents 60 providing a flow air over a wearer's head, or over a wearer's forehead, or over the back of the wearer's head. The vents 60 may be opened or closed by actuating handles 62. The vents 60 may further be rotatable to control the direction of air released through the vents 60.

While the invention has been described for use with an audio headset, noise reducing headsets are also commonly worn for extended periods of time and a noise reducing headset, with at least one fan for producing a flow of air past the wearer's ears, is intended to come within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. A fan cooled headset comprising:
two ear pieces for wearing over a wearer's ears;
an arced headpiece connecting the two ear pieces for wearing over the wearer's head;
an ear volume in each ear piece for containing the wearer's ears;
speakers within each ear piece providing sound to each ear volume;
at least one fan in fluid communication with ambient outside air and with the ear volumes to provide a flow of cooling ambient air past the wearer's ears.

2. The fan cooled headset of claim 1, wherein the fan receives power through a USB plug.

3. The fan cooled headset of claim 2, wherein the speakers receive signals through a USB plug.

4. The fan cooled headset of claim 3, further including a microphone attached to the headset by a stalk, wherein a microphone signal generated by the microphone is carried through the USB plug.

5. The fan cooled headset of claim 2, wherein the speakers receive signals through a stereo plug.

6. The fan cooled headset of claim 2, wherein the fan is a ducted fan.

7. The fan cooled headset of claim 2, wherein the fan is a blower.

8. The at least one fan cooled headset of claim 1, wherein two fans provide the flow of cooling air past the wearer's ears.

9. The at least one fan cooled headset of claim 1, further including vents attached to the head piece to provide a flow of air over a wearer's head.

10. The at least one fan cooled headset of claim 9, further including vents attached to the head piece to provide a flow of air over a wearer's forehead.

11. The at least one fan cooled headset of claim 9, further including vents attached to the head piece to provide a flow of air over a rear of the wearer's head.

12. The at least one fan cooled headset of claim 1, wherein the fan draws air from above the head piece and urges the air through the head piece and into the ear pieces to cool the wearer's ears.

13. The at least one fan cooled headset of claim 13, wherein the ambient air flows out of the ear pieces through ports on bottoms of the ear pieces.

14. The at least one fan cooled headset of claim 1, wherein the fan draws ambient air from the head piece and urges the air through the head piece and from the ear pieces to draw air into the ear pieces to cool the wearer's ears.

15. The at least one fan cooled headset of claim 14, wherein the ambient air is drawn into the ear pieces through ports on bottoms of the ear pieces.

16. The at least one fan cooled headset of claim 15, wherein filters reside over the ports on bottoms of the ear pieces.

17. The at least one fan cooled headset of claim 1, wherein the fans comprise one fan residing in each ear piece circulating ambient air through the ear pieces to cool the wearer's ears.

18. The at least one fan cooled headset of claim 1, wherein the cooling clips reside in the flow of ambient air to cool the air circulated through the ear pieces to cool the wearer's ears.

19. A fan cooled headset comprising:
two ear pieces for wearing over a wearer's ears;
an arced headpiece connecting the two ear pieces for wearing over the wearer's head;
an ear volume in each ear piece for containing the wearer's ears;
speakers within each ear piece providing sound to each ear volume;
a port in each ear piece placing the ear volume in fluid communication with ambient air.
a fan residing in the head piece and in fluid communication with ambient outside air and with the ear volumes and creating a flow through the head piece, past the wearer's ears and through the ports to cool the wearer's ears.

20. A fan cooled headset comprising:
two ear pieces for wearing over a wearer's ears;
an arced headpiece connecting the two ear pieces for wearing over the wearer's head;
an ear volume in each ear piece for containing the wearer's ears;
speakers within each ear piece providing sound to each ear volume;
a port in each ear piece placing the ear volume in fluid communication with ambient air.
a fan residing in each ear piece and in fluid communication between ambient outside air and with the ear volumes and creating a flow through the ear volume, past the wearer's ears and through the ports to cool the wearer's ears.
